(19) United States
(12) Patent Application Publication
(10) Pub. No.: US 2026/0191141 A1
(43) Pub. Date: Jul. 9, 2026

(54) MECHANICAL GRAPE HARVESTING MACHINE WITH A MEANS FOR CONTINUOUSLY MONITORING THE WEIGHT OF THE GRAPE HARVEST

(71) Applicant: PELLENC, Pertuis (FR)

(72) Inventors: Matthieu HAMEL, Pertuis (FR); Alexandre ROGIER, Cadenet (FR)

(21) Appl. No.: 18/569,373

(22) PCT Filed: Jun. 24, 2022
(86) PCT No.: PCT/IB2022/055869

§ 371 Date: Jul. 8, 2024

(30) Foreign Application Priority Data
Jun. 25, 2021 (FR) 2106819

(51) Int. Cl. A01D 46/28; A01D 67/00; G01G 19/08

(52) U.S. Cl. CPC A01D 46/28; A01D 67/00; G01G 19/08

(57) ABSTRACT

A grape harvesting machine including a frame, a vine row shaking assembly adapted to separate the grape harvest from the vine rows, one or more storage bins each fastened to a bin bracket and a device for measuring the weight of the grape harvest that has accumulated in the storage bins; in which machine the bins are connected to their bin brackets via load sensors so that the storage bins are suspended from their respective bin brackets, the sensors are arranged above the shaking assembly, and the measuring device is configured to process the signals from the load sensors and to continuously or cyclically output a measurement signal representative of the weight of the grape harvest.

### TECHNICAL FIELD

The invention relates to a grape harvesting machine capable of proceeding with harvesting grapes and storing them in a bin while assessing the amount of harvested grapes.

### PRIOR ART

In the vine sector, harvesting grapes is historically implemented manually, but is increasingly often carried out mechanically, by means of a harvesting head embedded on or towed by a grape harvesting machine which travels through the vine rows in a vineyard, the harvesting head mechanically separating the grapes from the vines through a mechanical shaking action and temporarily storing them in a storage bin until emptying the bin by tilting at a collection point.

Harvesting machines of this type may be self-propelled (the tractor vehicle embeds a harvesting head and straddles over the vine row) or towed (the harvesting head straddling over the vine row is towed by a tractor vehicle traveling between two vine rows).

It should be noted that by “mechanical grape harvesting”, it should be understood the operation of harvesting grapes by means of a grape harvesting machine and by “grape harvest”, it should be understood the harvested grapes.

In this context, continuously monitoring the weight of the grape harvest stored in the bin has many advantages, such as the possibility for the grape harvesters to know, in real-time, the yield per hectare of their land parcels, to establish parcel maps that can be used to locally guide, for example, the amount of fertilizers and/or the volume and type of phytosanitary treatments to be applied or to adapt treatments throughout the year, or to comply with regulatory harvest quotas per hectare or to adjust the amount of grape harvest to be delivered to the cellar so that it is vinified as quickly as possible.

Thus, the patent document FR 2 768 222 B1 describes an on-board continuous grape harvest weighing device using a first electronic scale assessing the weight of a weighing tray over which a grape harvest drive system passes.

A second electronic scale arranged proximate to the first one and supporting a known fixed mass is used as a control so as to correct the dynamic disturbances affecting the two scales in a substantially equivalent manner.

However, this device requires a drive system capable of containing the grape juice, and it is not designed to avoid taking undesirable objects into account (pieces of vine stocks or stakes, etc.).

The patent document WO2018/122280 also discloses a grape harvesting machine and a method capable of continuously measuring the weight of the grape harvest stored in its bins.

This weight is assessed by measuring the hydraulic pressure in the lifting cylinders of the machine and requires a systematic calibration when emptying the bins by comparing the hydraulic pressures in the lifting cylinders of the machine before and after emptying.

This system lacks reliability because the oil pressure in the cylinders changes with its temperature, thereby the need to perform specific calibration procedures when emptying the bins.

Hence, the best accuracy obtained is achieved only statically when emptying, yet provided that the wheels are very stable at this time point.

Moreover, the considered lifting cylinders are the cylinders linking the undercarriage of the frame to the wheels of the machine, thereby supporting the weight of the entire grape harvesting frame, of the grape harvest being harvested including undesirable wastes and of the grape harvest that has accumulated in the bins.

Hence, the measurement accuracy is far from satisfactory given the complexity of this method.

Hence, the device and the method disclosed by this document are not suitable for continuous and accurate measurement of the weight of the grape harvest stored in the bins during the mechanical grape harvesting.

### Disclosure of the Invention

The invention aims to provide a means suited for accurate and continuous monitoring of the weight of the grape harvest stored in the bins of the grape harvesting head of a grape harvesting machine.

To this end, the invention relates more particularly to a grape harvesting machine intended to harvest a grape harvest, including a frame mounted on at least one wheel train each of which is movable about a wheel train axis, said frame being arranged so as to straddle over a vine row during a mechanical grape harvesting, a vine row shaking assembly in mechanical connection with the frame, capable of separating the grape harvest from the vine row, an assembly for collecting and conveying the grape harvest from the shaking assembly to one or more storage bin(s), each storage bins being fastened to an associated bin bracket pivotably mounted about a bin pivot shaft mechanically linked to the frame to ensure emptying of the storage bins, and a device for measuring the weight of the grape harvest that has accumulated in the storage bins, a grape harvesting machine in which each storage bin is connected to the associated bin bracket via load sensors, the load sensors being elongate shaped bending sensors each having two fastening ends, a first fastening end being fastened to the storage bin and a second fastening end being fastened to the associated bin bracket so that the storage bin is suspended from the associated bin bracket, the fastening ends of the load sensors are arranged above the shaking assembly when the machine is located on a horizontal planar ground, each load sensor is powered by the grape harvest weight measuring device to output a sensor signal at any time during the mechanical grape harvesting, and the measuring device is configured to process the signals from the load sensors and continuously or cyclically output a measurement signal representative of the weight of the grape harvest that has accumulated by the grape harvesting machine in the storage bins.

The above-described grape harvesting machine is capable of continuously measuring the weight of the grape harvest stored in the storage bins during mechanical grape harvesting while ensuring mechanical holding, in particular during mechanical grape harvesting or emptying.

The mechanical hold of the storage bins is ensured by the load sensors, which achieves the two functions of suspending each bin from a bin bracket associated therewith, i.e. avoiding any mechanical fastening of the bin with any element other than the load sensors, and to detect the forces that the storage bins exert on each of them, which, by adding their sensor signals, allows deducing the weight of the storage bins and their content, the harvest, which will be transported to the cellar after emptying the bin.

Each storage bin being mechanically fastened to the associated bin bracket, the mechanical stability of the storage bins is ensured, in particular during mechanical grape harvesting or emptying.

Furthermore, the load sensors being located above the shaking assembly, the shaking operations disturb the sensor signals representing the weight of the storage bins during mechanical grape harvesting much less than is the case if they were located at a same horizontal level as the shaking assembly.

Thus, the features of the grape harvesting machine effectively enable a continuous control of the weight of the storage bins during mechanical grape harvesting, even on an uneven terrain with slopes and downhills, which are common circumstances in vineyards.

The grape harvesting machine may have the following features for each storage bin:
the fastening ends of the load sensors may be arranged above a center of gravity of the storage bin when the machine is located on a horizontal planar ground;
when the machine is located on horizontal planar ground, the center of gravity of the empty storage bin may be located more than 15% of the depth of the storage bin under the fastening ends;
the machine may comprise at least three load sensors suspending the storage bin from the bin bracket, which may be distributed so that two of these sensors are distant by at least 60% of the width of the storage bin according to a direction substantially parallel to the wheel train axis, and that two of these sensors are distant by at least 70% of a length of the storage bin according to a direction substantially horizontal and perpendicular to the wheel train axis, the storage bin being considered in the grape harvesting position on a horizontal planar ground;
the machine may comprise four load sensors suspending the storage bin, a first and a second of these sensors may be arranged at a front portion of the storage bin and distant from each other by at least 60% of the width of the storage bin according to a direction substantially parallel to the wheel train axis, a third and a fourth of these load sensors may be arranged at a rear portion of the storage bin and distant from each other by at least 60% of the width of the storage bin, the first and the third of the load sensors may be distant from each other by at least 70% of the length of the storage bin according to a substantially horizontal direction and perpendicular to the wheel train axis, the storage bin being considered in the grape harvesting position on a horizontal planar ground;
the storage bin may include bin rising edges, the first fastening ends of the load sensors being able to be fastened at less than 20% of a width of the storage bin from one of said bin rising edges;
at least one of the load sensors may be located between the storage bin and a driver cabin of the grape harvesting machine and may have a longitudinal axis substantially parallel to the wheel train axis of the grape harvesting machine; and
a ratio of a sum of absolute values of the measurement capacities of the load sensors to an expected maximum total weight of the storage bin may be greater than 2.

### BRIEF DESCRIPTION OF THE DRAWINGS

The present invention will be better understood and other advantages will appear upon reading the detailed description of an embodiment considered as a non-limiting example and illustrated by the appended drawings, wherein:

FIG. 1A illustrates a side view of a self-propelled harvesting machine according to the invention, in a mechanical grape harvesting position;

FIG. 1B illustrates a top view of the grape harvesting machine of FIG. 1A;

FIG. 1C illustrates the grape harvesting machine of FIG. 1A in an emptying position;

FIG. 2A is a three-dimensional (3D) figure showing a storage bin and its bin bracket;

FIG. 2B is a side view of an empty storage bin showing the position of its center of gravity;

FIG. 3A is a diagram illustrating a bending load sensor and fastening thereof between a storage bin and a bin bracket;

FIG. 3B is an extract from a 3D view of the grape harvesting machine of FIG. 1A upstream of a storage bin at fastening thereof with the bin bracket;

FIG. 3C is an extract from a 3D view of the grape harvesting machine of FIG. 1A downstream of a storage bin at fastening thereof with the bin bracket;

FIG. 4 shows the evolution over time of the weights measured by a set of 8 load sensors of a grape harvesting machine recorded during a mechanical grape harvesting, as well as their sum.

FIG. 5 shows a block diagram of processing of the signals of the load sensors.

### DESCRIPTION OF A PARTICULAR EMBODIMENT OF THE MACHINE ACCORDING TO THE INVENTION

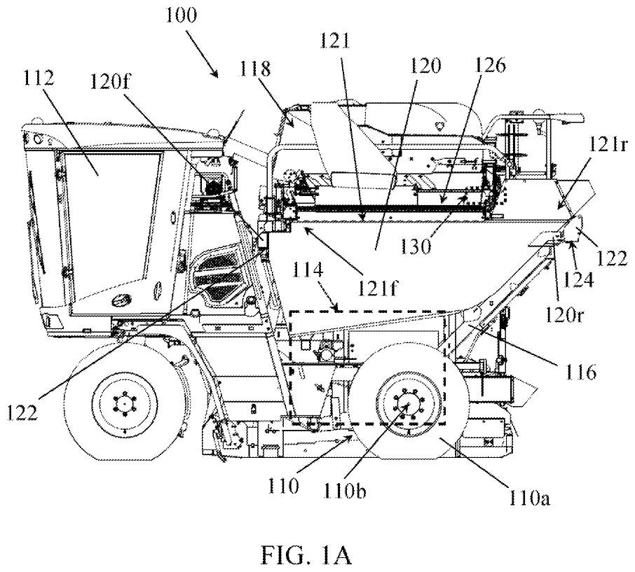

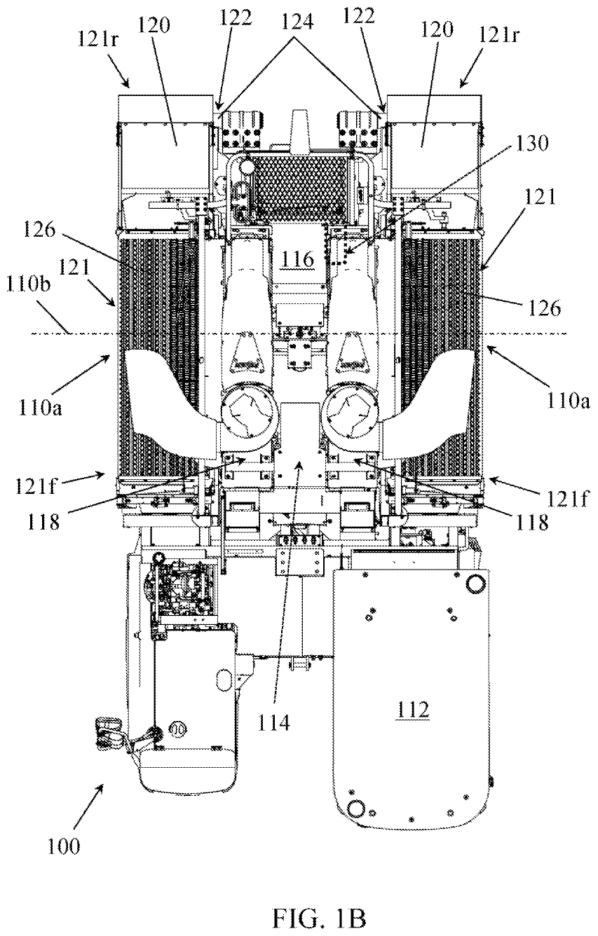

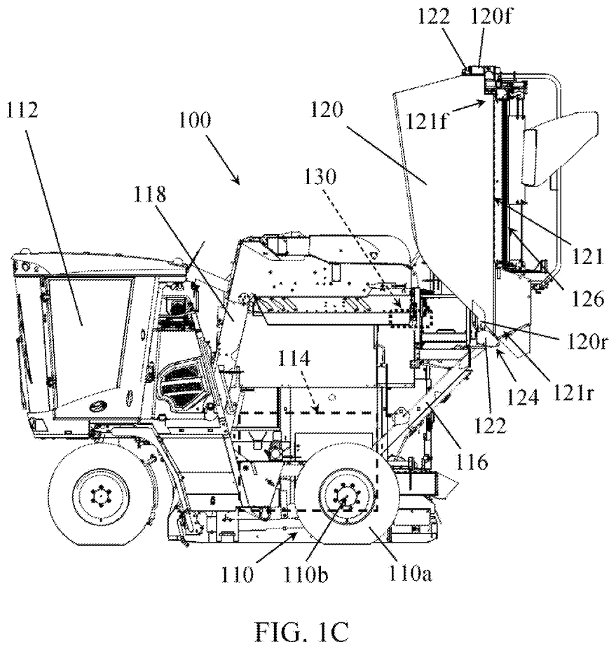

This embodiment is illustrated by FIGS. 1A to 5.

FIGS. 1A to 1C illustrate a grape harvesting machine 100, FIG. 1A showing it in side view in a configuration suited for mechanical grape harvesting, FIG. 1B being a top view of the machine in this same configuration and FIG. 1C being a side view showing the grape harvesting machine in an emptying configuration.

The grape harvesting machine 100 comprises at least one wheel train 110 supporting in particular a driver cabin 112 and a shaking assembly 114, located in the grape harvesting machine 100 by dotted lines, mounted on a frame 116.

The wheel train 100 comprises wheels 110a each of which is movable about a wheel train axis 110b.

When the frame 116 is mounted on or constitutes a portion of a tractor frame supporting the driver cabin, the grape harvesting machine is in a self-propelled version and the tractor frame then includes two wheel trains for steering and moving the grape harvesting machine.

The frame 116 may also include only one wheel train 110 and then form a portion of a towed grape harvesting machine, which will be towed by an agricultural tractor also including a driver cabin and circulating between the vine rows to move the grape harvesting machine.

The frame 116 is designed so as to straddle over a vine row when the grape harvesting machine implements a mechanical grape harvesting operation, an operation during which a grape harvest is harvested, essentially including grape berries detached from the vine row which carries them, associated with the grape juice when the berries are crushed, by mechanical shaking at high frequency (in the range of 5 to 10 Hz) applied at the area of the vine row including the grape berries by means of the shaking assembly 114.

The grape harvest detached from the vine row is recovered by a collection and conveying assembly 118 fastened on the frame 116, an assembly including for example at least one endless conveyor belt associated with cleats or buckets, and is transported to two storage bins 120 located symmetrically on either side of the machine 100, as shown in FIG. 1B, close to the frame 116 and behind the driver cabin 112, into which it falls to be stored until emptying the storage bins by tilting, an operation illustrated in FIG. 1C with a bin 120 visibly tilted into a vertical position, i.e. in the emptying position.

In contrast to FIG. 1C, FIG. 1A illustrates the grape harvesting machine in a mechanical grape harvesting configuration on a horizontal planar ground, with a storage bin 120 in a horizontal position, i.e. in the mechanical grape harvesting position.

For the purpose of emptying by tilting, each storage bin 120 is mounted on a bin bracket 122 with which it is associated, each bin bracket being pivotably mounted about a bin pivot shaft 124 mechanically linked to the frame 116 to switch the associated storage bin from the mechanical grape harvesting position into the emptying position.

In the rest of this document, the description will generally focus on only one of the storage bins, bearing in mind that the features of one of the bins and coupling thereof with the grape harvesting machine, via a bin bracket for the mechanical aspect, also apply to the other bin.

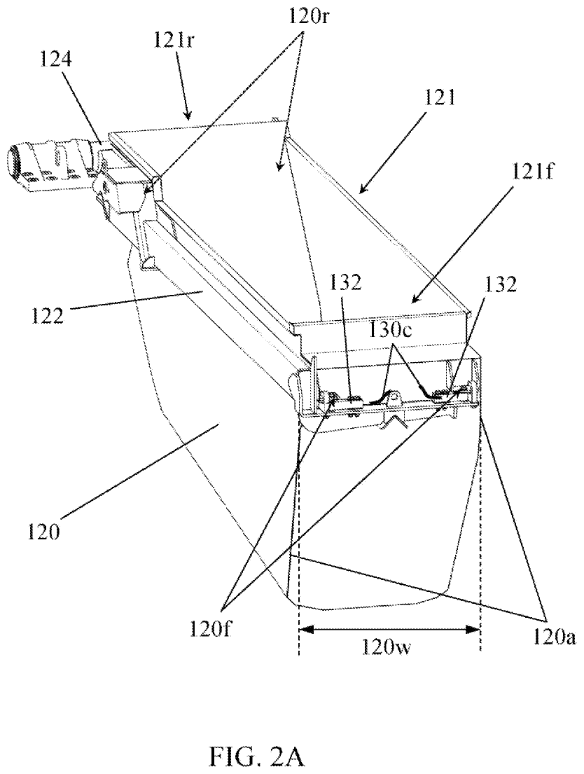

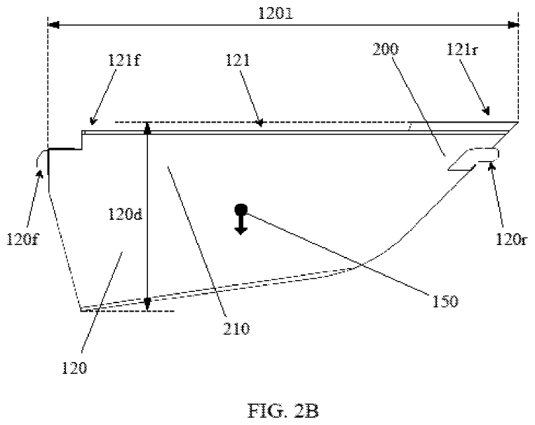

FIG. 2A shows a 3D view of a storage bin 120 associated with its bin bracket 122 and with the bin pivot shaft 124.

The storage bin 120 has generally prismatic geometric shapes adapted to conform to the grape harvesting machine and defining a sealed container with a given grape harvesting volume with a bin inlet opening 121 with a generally rectangular shape when viewed from the top, located at the top of the storage bin and throughout which the grape harvest is poured.

The bin inlet opening 121 has an elongate shape, longer (in the direction of movement of the machine) rather than wide and has a front portion 121f corresponding to the front of the grape harvesting machine, close to the driver cabin, and a rear portion 121r corresponding to the rear of the grape harvesting machine, close to the emptying pivot 124 of the bin bracket 122.

It is possible to characterize the storage bin by its width 120w, corresponding to its maximum extent in a direction substantially parallel to the axis 110b of the wheel train of the machine, and by its length 1201, corresponding to its maximum extent according to a direction substantially horizontal and perpendicular to the wheel train axis, the storage bin being considered in the mechanical grape harvesting position on a horizontal planar ground, as illustrated in FIGS. 2A and 2B, respectively.

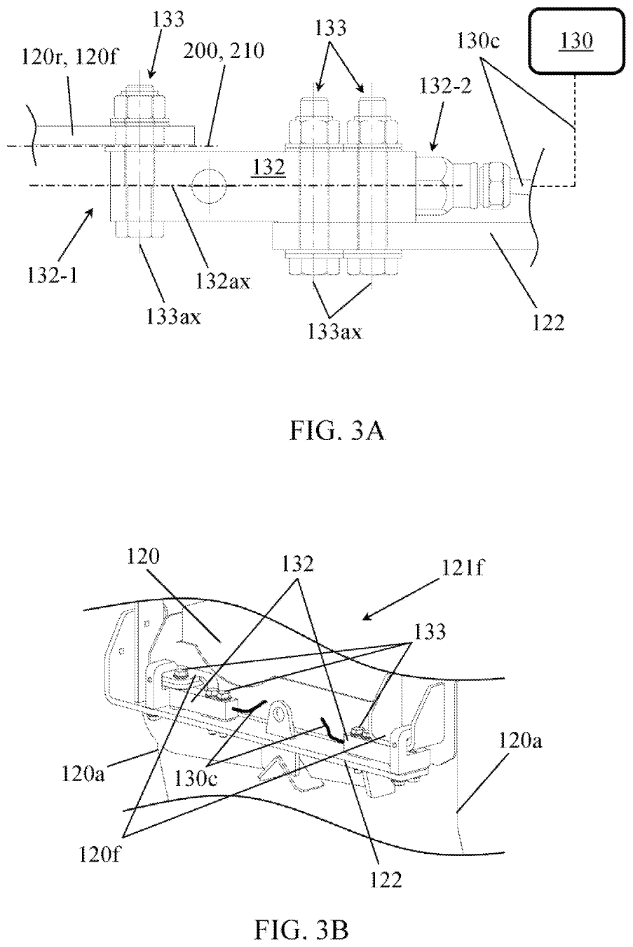

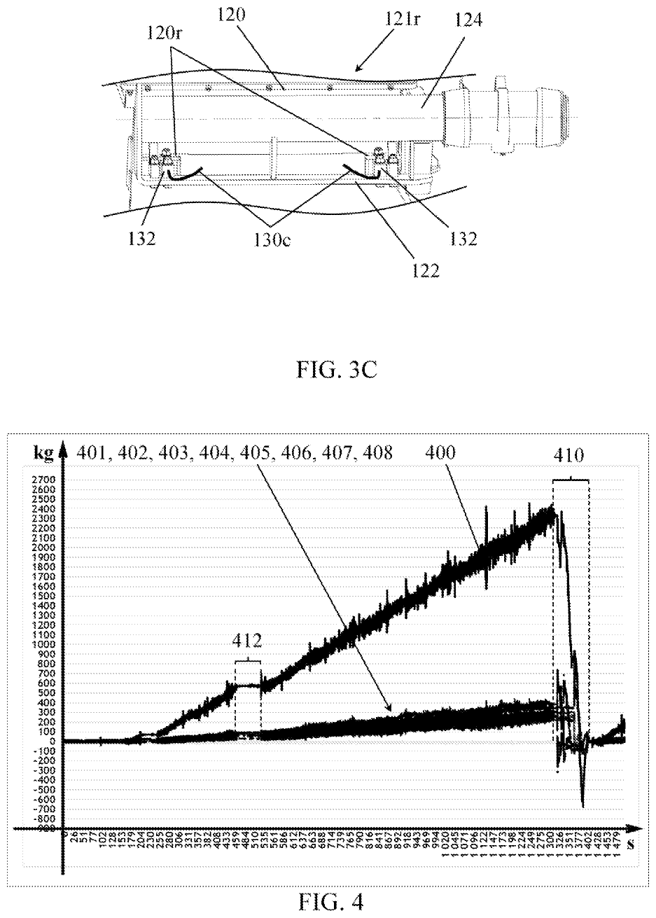

The storage bin 120 includes two fastening lugs 120f, visible in particular in FIGS. 2A, 2B and 3B, arranged according to a width of the storage bin proximate to the front portion 121f of the bin inlet opening 121, and two rear fastening lugs 120r, visible in particular in FIGS. 2B and 3C, arranged according to a width of the storage bin proximate to the rear portion 121r of the bin inlet opening 121.

As illustrated in FIG. 2B, the fastening lugs 120f define a front horizontal fastening plane 210 and the fastening lugs 120r define a rear horizontal fastening plane 200, the storage bin being considered in a mechanical grape harvesting position on a horizontal planar ground, a position illustrated in FIG. 1A.

The two horizontal fastening planes 200 and 210 are arranged between a horizontal plane defined by the bin inlet opening 121 (and corresponding to the lowest vertical point of the opening 121 when the machine is located on a horizontal planar ground, in the mechanical grape harvest configuration) and a horizontal plane including a center of gravity 150 of the storage bin schematized in FIG. 2B for an empty storage bin.

The fastening lugs 120r and 120f, 4 in number in total, serve to rigidly suspend the storage bin 120 from a bin bracket 122 via 4 load sensors 132, the storage bin being kept distant from the bin bracket via load sensors, and rigidly held on the grape harvesting machine, in particular during the mechanical grape harvesting or emptying operations.

It is specified that the storage bin could be a simple container comprising walls defining a waterproof portion capable of storing the grape harvest, but it could be formed by several portions, for example a waterproof container associated with a frame which is rigidly fastened thereto.

In the latter case, all of the portions forming the storage bin are suspended from the bin bracket via the load sensors.

As illustrated in FIG. 3 A, each sensor extends according to a sensor longitudinal axis 132ax and has two fastening ends, a first fastening end 132-1 being fastened to one amongst the fastening lugs 120f, 120r of the storage bin and a second fastening end 132-2 being fastened to the bin bracket 122 so that the storage bin 120 is suspended from the bin bracket 122, the sensors forming an assembly for suspending the storage bin from the bin bracket.

By “suspended”, it should be understood that the storage bin is entirely held in the air by the bin bracket via the load sensors 132, without elements other than the load sensors having a significant contribution to the mechanical hold of the storage bin.

For example, it is considered that the electrical connection cables 130c connecting the sensors to the measuring device 130 do not form elements having a significant mechanical contribution to holding of the storage bin.

The same applies, where appropriate, to electrical cables or hydraulic supply hoses of a sorting table.

The bin bracket 122 is a rigid structure surrounding the storage bin on 3 sides, in particular opposite the fastening lugs 120f and 120r.

The fasteners are made by means of mounts by bolts 133 passing through the bodies of the sensors perpendicular to their respective longitudinal axes, the bolts 133 being visible for example in FIG. 3B, such that, during mechanical grape harvesting, the horizontal axes of the sensors extend horizontally, the longitudinal axes 133ax of the bolts extending vertically, always in a mechanical grape harvesting configuration on a horizontal planar ground.

Thus, the storage bin is rigidly fastened to the associated bin bracket and can withstand mechanical stresses in the mechanical grape harvesting or emptying configuration.

The configuration hereinabove has the advantage of good holding of the storage bin combined with a configuration capable of accurately assessing the weight of the contents of this storage bin and its possible accessories.

Such an assembly allows ensuring a reliable measurement of the grape harvest weight, since only the entire weight carried by a storage bin rests on the load sensors.

As regards the vertical positioning of the load sensors, which also serve as a mechanical suspension of the storage bin to which they are fastened, the fastening ends of the load sensors, and therefore the fastening lugs 120r and 120f, are arranged above the center of gravity 150 of the storage bin when the machine is located on horizontal planar ground, the center of gravity of the empty storage bin being preferably located more than 15% of a depth 120 d of the storage bin under the fastening ends.

The depth 120d of the storage bin should be understood as the vertical distance separating the highest point of the bin inlet opening 121 from the lowest point of the storage bin, as indicated in FIG. 2B, in a horizontal position configuration of the storage bin, i.e. with the storage bin in a grape harvesting position, the machine being on horizontal planar ground.

Such a configuration has the advantage of a substantial improvement in the mechanical stability of the suspended storage bin, in particular on an uneven terrain and/or a terrain featuring a declivity.

In order to limit the disturbances of weighing by the shaking operation which generates mechanical vibrations not only at the vine row but also at the grape harvesting machine, the fastening ends of the sensors are arranged in horizontal planes located above the shaking assembly materializing the area where the mechanical grape harvest is located and therefore where the vibrations are maximum, the machine being considered during mechanical grape harvesting on a horizontal terrain.

Such an arrangement has the advantage of moving the sensors away from the area where the vibrations generated for the shaking operation are concentrated, so that the vibration level at the locations of the sensors remains acceptable for weight measurements.

Placing the sensors above the center of gravity of the storage bin also enhances the attenuation of the forces by the inertia of the intervening masses at the center of gravity.

Under normal conditions, the presence of an amount of grape harvest in the storage bin will only enhance its stability, the density of the grape harvest being greater at the bottom of the tank due to packing of the grapes and the presence of juice.

As regards the number and the horizontal positions of the load sensors on the periphery of a storage bin, preference is given, in a general case, to the arrangement of at least 3 load sensors arranged at a distance from each other, in particular with at least one first sensor arranged at the front of the storage bin, at least one second sensor arranged at the rear of the storage bin and at least one third sensor arranged at a distance from the other sensors according to a direction parallel to the axis of the wheel trains, so as to form a support polygon of the storage bin having a surface area as large as possible.

Thus, it is possible to have at least three load sensors suspending the storage bin from the bin bracket, distributed so that two of these sensors are distant by at least 60%, preferably 70%, even more preferably 80%, of the width of the storage bin according to a direction substantially parallel to the wheel train axis, and that two of these sensors are distant by at least 70%, preferably 80%, even more preferably 90% of a length of the storage bin according to a direction substantially horizontal and perpendicular to the wheel train axis, the storage bin being considered in the grape harvesting position on a horizontal planar ground.

Such a configuration has the advantages of a good mechanical stability as well as a homogeneous distribution of the loads to be measured between the sensors, allowing minimizing the effects of slopes or downhills, both for the mechanical holding of the storage bin and for the measurement of the weight of the grape harvest.

The arrangement of remote load sensors in a direction parallel to the wheel train axis 110b, and therefore according to the width of the storage bin, advantageously allows taking into account downhills, the grape harvesting machine being capable of leaning to the left or to the right during mechanical grape harvesting.

Similarly, the arrangement of remote load sensors in a direction perpendicular to the wheel train axis 110b, and therefore according to the length of the storage bin, advantageously allows taking the slopes into account.

In the present embodiment, each storage bin is suspended by 4 sensors distributed around the bin inlet opening: two in the front portion 121f and two in the rear portion 121r of the storage bin, arranged symmetrically on each side of the storage bin, close to each corner of the elongate quadrilateral formed by the bin inlet opening when viewed from above, thereby maximizing the surface area of the support polygon of the storage bin.

More specifically, four load sensors suspend the storage bin, a first and a second of these load sensors being arranged at the front of the storage bin and distant from each other by at least 60%, preferably 70%, even more preferably 80%, of the width of the storage bin according to a direction substantially parallel to the wheel train axis, a third and a fourth of these load sensors being arranged at the rear of the storage bin and distant from each other by at least 60%, preferably 70%, even more preferably 80%, of the width of the storage bin according to the direction substantially parallel to the wheel train axis, the first and third of the load sensors being distant from each other by at least 70%, preferably 80%, even more preferably 90% of a length of the storage bin according to a direction substantially horizontal and perpendicular to the wheel train axis, the storage bin being considered in the grape harvesting position on a horizontal planar ground.

The positioning of the sensors at a distance from one another, in a direction of advance of the machine and in a direction perpendicular to the latter, allows limiting errors in the measurement of the load of the storage bin despite angular positions of the measurement axis different from the axis of the weight of the storage bin according to the angular positions of the grape harvesting machine in slopes or in downhills and therefore improves the robustness of the measurement of the weight of the storage bin on slopes when the grape harvesting machine goes up or down, and even in the presence of downhills.

The multiplication of load sensors arranged at a distance from each other around the bin inlet opening 121 enhances the reliability of the measurement of the weight of the storage bin and its content, while enhancing the reliability of the mechanical hold of the storage bin on the bin bracket.

Thus, the Applicant has been able to measure, for example by using a grape harvesting machine according to the present claim, errors less than 1% for each 10% slope range (uphill or downhill) of the terrain on which the mechanical grape harvesting is practiced, thereby demonstrating that the declivity of the terrain does not significantly disturb the assessment of the amount of grapes harvested during mechanical grape harvesting.

However, it is still possible to take into account a measurement of the trim of the grape harvesting machine to calculate the weight of the grape harvest even more accurately according to known methods, using a trim measuring device.

It is also preferable to fasten the first ends 132-1 of the load sensors 132 proximate to rising edges 120 a of the storage bin 120, preferably at less than 30%, more preferably at less than 20%, of the width 120 w of the storage bin of one of the rising edges 120a of the storage bin.

These edges join the bottom of the storage bin to its inlet opening 121 in the manner illustrated in FIG. 2A.

Such a configuration has the advantage of stiffening fastening of the storage bin on the bin bracket, which increases on the one hand the mechanical stability of the assembly and on the other hand the reliability of the machine by reducing the mechanical fatigue.

In the upstream portion 121f of the storage bin, the two load sensors are close to the control cabin 112 of the grape harvesting machine 100.

As shown in FIG. 3B, they are fastened between the fastening lugs 120f of the storage bin 120 and the bin bracket 122 having their longitudinal axes 132ax positioned along the front lateral wall of the storage bin 120, and therefore substantially parallel to the wheel axis 110b.

This configuration has the advantage of limiting the size of the suspension assembly of the storage bin so that the latter could usefully occupy the space located at the rear of the driver cabin and therefore increase the grape harvest storage volume of the grape harvest machine without increasing its overall size.

In the downstream portion of the storage bin, the size constraints are not the same, and as shown in FIG. 3C the two load sensors are fastened between the rear fastening lugs 120r of the storage bin 120 and the bin bracket 122 by having their longitudinal axes perpendicular to the rear lateral wall of the storage bin and therefore substantially perpendicular to the wheel axis 110b of the grape harvesting machine 100.

In this document, the “perpendicular” and “parallel” characteristics could be understood respectively as departing from angles strictly amounting to 90° and 0°, and respectively comprise orientation angular ranges of 90±10° and 0±10°, which could be denoted by the expressions “substantially parallel” and “substantially perpendicular”.

Similarly, the “vertical” and “horizontal” characteristics could be understood respectively as departing from a strictly vertical direction and a strictly horizontal plane by ±10°, which could be denoted by the expressions “substantially vertical » and “substantially horizontal”.

Of course, other configurations, in number and positioning of sensors are possible, depending on the exact configuration of the considered grape harvesting machine, but the sensors should be used in a sufficient number, such that the load capacity of the set of sensors supporting the storage bin is enough to support the added weights of the storage bin, of the grape harvest that it is likely to store and, where appropriate, of the sorting table equipping the storage bin.

Optionally, each of the two storage bins 120 of the grape harvesting machine 100 may be equipped with a sorting table 126 fastened to the storage bin 120 and located above the bin inlet opening 121.

Such a sorting table, visible in FIGS. 1A to 1C, allows sorting the grape harvest derived from the mechanical grape harvesting conveyed by the collection and conveying assembly to reject undesirable wastes (leaves, leafstalks, shoots, pieces of vines, etc.) and keeping essentially only the grape harvest in the storage bin.

Once the bins are filled or a fixed grape harvest quota has been reached, the grape harvesting machine is brought to a collection point where the storage bins are emptied.

In general, this collection point is a trailer ensuring the transport of the grape harvest to the cellar to be vinified there.

Nonetheless, the quality of the subsequent vinification depends on the time elapsed between the mechanical grape harvesting of the berries and their vinification in the cellar.

This time should be as short as possible to preserve the quality of the grape harvest, the cellar should avoid receiving simultaneously several grape harvest trailers which could therefore sometimes wait for several hours before being vinified.

To limit these waiting times, the cellar may impose grape harvest quotas over time to ensure the quality of the vinification, thereby requiring a continuous monitoring of the weight of the grape harvest that has accumulated in the storage bins 120 during the mechanical grape harvesting.

To this end, the grape harvesting machine 100 is equipped with a device 130 for continuously or cyclically measuring the weight of the grape harvest that has accumulated in the storage bins, this device being functionally connected to the load sensors 132 of each of the storage bins as illustrated by the dotted line connection in FIG. 3A, for example by electrical connection cables 130c.

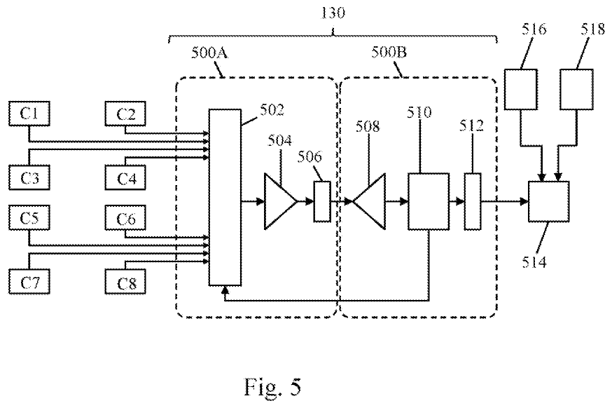

The measuring device 130 is a waterproof electronic box, arranged at the height of the grape harvesting machine 100 proximate to the different load sensors, configured to power the 8 load sensors 132 of the two storage bins of the grape harvesting machine, process the signals 401 to 408 generated respectively by the eight load sensors 132 designated by C1 to C8 in the block diagram of FIG. 5, and continuously or cyclically output a measurement signal representative in real-time of the weight of the grape harvest harvested by the grape harvesting machine, a weight indicated in kilograms on the ordinate of the graph in FIG. 4, the abscissa axis representing time in seconds.

This measurement signal is calculated by the measuring device based on a sum 400 of the signals 401 to 408 derived from the 8 load sensors C1 to C8 and indicating the weight of the grape harvest stored in the two storage bins 120 of the grape harvesting machine 100 of this embodiment.

Of course, it is possible to calculate in a differentiated manner the weight of the grape harvest stored in each of the storage bins by separately summing up the signals from the sensors fastened to each storage bin and thus resulting in two measurement signals each representative in real-time of the weight of the grape harvest stored in one of the two storage bins.

The graph in FIG. 4 shows that the sensors C1 to C8 measure, in this example, weights close to each other, which causes the corresponding curves to be superimposed, the variations in measurements due for example to the movements of the grape harvesting machine on an uneven terrain not preventing a reliable monitoring of the amount of grape harvest harvested in real-time with an almost linear variation of the overall weight of the grape harvest with the grape harvesting duration, breaks in grape harvesting, and therefore in the evolution of the curves, occurring for example during a U-turn to move from one vine row to the next one as in 412.

The area 410 illustrates the information derived from the load sensors when the storage bins are tilted for emptying and then shows the inconsistencies of the signals in this phase, the sensors not being adapted to measure when the storage bin is pivoted.

Nonetheless, important data on the value of the content of the grape harvest may be transmitted reliably and accurately during mechanical grape harvesting and before pivoting of the storage bin.

The communication of the accumulated grape harvest weight may also be interrupted as soon as emptying is activated.

FIG. 5 illustrates the measuring device 130, with an analog portion 500A for the analog processing of the signals, including the connection of the analog signals from the eight load sensors C1 to C8 to an amplifier 504 and an RC filter 506 via a multiplexer 502.

A digital portion 500B of the measuring device comprises an analog-to-digital decoder 508 receiving the filtered signals originating from the RC filter, a microprocessor 510 controlling the multiplexer 502 and processing the digital signals generated by the decoder 508, and a bus 512 of bidirectional serial data of the CAN (Control Area Network) type transmitting the processed digital signals to a human-machine interface 514 such as a computer terminal having calculation capabilities and equipped with a touchscreen, located in the driver cabin.

Thus, the measuring device may communicate values representative of the weight of the grape harvest that has accumulated in the bins at a given time to the driver cabin, values obtained by filtering and calculations on the raw data of the sensors.

Alternatively, these representative values may be sent directly to the cellar, allowing anticipating the collection operations, or the cellar may define a grape harvest weight objective which will then define an alert signal sent to the machine during grape harvesting or communicated to the driver of the grape harvesting machine as soon as this grape harvest weight is close to being reached in the storage bins.

This consists of a differential measurement, taking into account only the variation of the signals of the sensors over time, so as to take into account only the weight of the stored grape harvest, while not taking into account the weight of the empty storage bin (in the case of a storage bin equipped with a sorting table, it is also possible not to take into account the weight of the sorting table).

The load signals generated by each of the sensors are added by the microprocessor so as to obtain the overall weight of the grape harvest stored in both storage bins.

The above-described embodiment illustrates the situation of a grape harvesting machine comprising two storage bins, but the invention extends of course to grape harvesting machines including a different number of storage bins, such as one, three or four for example, and it should be understood that the sum of the sensor signals concerns all of the sensors of the considered storage bins, one single bin, where appropriate in the case of a grape harvesting machine, including only one.

It is also possible to associate the measurement data with an instantaneous position of the grape harvesting machine obtained by a satellite positioning system 516 connected to the interface 514, so as to establish a yield map of the vines being harvested.

It is also possible to use a trim measuring device 518 connected to the interface 514 in order to perform a trim correction in the calculation of the weight in order to take into account slopes and downhills.

It is also possible to use a data communication device (GSM or others) communicating the data bilaterally with the cellar for example.

The measuring device is herein equipped with a conventional RC filter in the analog portion of the circuit, but the filtration method is not limited to this example, what matters consisting in limiting the dynamic disturbances due to the advance of the grape harvesting machine on an uneven ground or to the vibrations generated by the shaking assembly.

In the present embodiment, the load sensors are bending load sensors, each set of load sensors being arranged so as to fill the two functions of (1) suspending a storage bin 120 from the corresponding bin bracket 122 and (2) measuring the weight of this storage bin and its contents and, where appropriate, the accessories with which it can be equipped like for example a sorting table.

It is also possible to calibrate the sensors before each mechanical grape harvest by measuring the empty weight and then giving only the evolution of the weight of the grape harvest during the mechanical grape harvesting.

As regards the type of the sensors, it is possible for example to use SB14 type bending sensors, produced by the manufacturer Flintec.

Each of these sensors measures a load in one single direction, that given by the longitudinal axis 133ax of the fastening bolts 133 of the sensor, the direction is vertical in this embodiment.

In full configuration and with a sorting table, the total weight of a storage bin is in the range of 2,200 kg maximum.

In the present embodiment, four SB14 bending load sensors of type 50001b each having a measuring capacity varying between −2,268 kg and +2,268 kg are used to suspend each storage bin from the bin bracket, leading to a measurement overcapacity factor greater than 4, this factor being assessed by the ratio of the sum of the absolute values of the capacities of the 4 load sensors to the expected maximum total weight, namely (2,268×4)/2,200.

The expected total weight for a storage bin corresponds to the added weight of the element(s) forming the storage bin, the maximum weight of grapes being considered equivalent to the weight of a volume of water equal to the inner volume of the storage bin and, where appropriate, a sorting table fastened on the storage bin.

The measuring capacity of a sensor corresponds to the maximum load it is capable of supporting and measuring according to the data of the sensor supplier.

The sensors, ensuring the mechanical connection between the storage bin and the bin bracket, should in fact support the storage bin irrespective of the configuration, during the mechanical grape harvesting phase where they withstand all vibrations and shocks caused by shaking or the advance of the machine on a ground that is sometimes chaotic and uneven, but also in the emptying phase.

A first reason for the measuring overcapacity of the sensors is that this overcapacity is an indicator not only of the limits in terms of measurement of the sensors, but also of their limits in terms of mechanical strength.

Such overcapacity allows ensuring the mechanical reliability of the suspension, taking into account the irregularity of the harvesting grounds and the vibrations and shocks caused by the different operations of the storage bin.

A second reason for the measurement overcapacity, by a factor greater than 4 in this embodiment (the set of 4 sensors is capable of measuring more than 4 times the expected maximum weight of the storage bin being used), is justified by the vibrations of the shaking system resulting in a disturbance of the measurement signals recorded by the load sensors.

Thus, a high overcapacity factor makes the load sensors less sensitive to vibrations and shocks, damping load peaks and enabling their correction more easily through a subsequent filtering of the signal.

Thus, the ratio of the sum of the absolute values of the capacities of the load sensors to the expected maximum total weight of the storage bin is preferably greater than 2, more preferably greater than 3, even more preferably greater than 4.

It goes without saying that the present invention cannot be limited to the embodiment disclosed hereinabove, which could be subject to modifications yet without departing from the scope of the invention

1. A grape harvesting machine intended for harvesting a grape harvest, the grape harvesting machine comprising:
a frame mounted on at least one train of wheels each of which is movable about a wheel train axis said frame being arranged so as to straddle over a vine row during a mechanical grape harvesting;
a vine row shaking assembly in mechanical connection with the frame, capable of separating the grape harvest from the vine row;
an assembly for collecting and conveying the grape harvest from the shaking assembly up to one or more storage bin(s) each of the storage bins being fastened to an associated bin bracket pivotably mounted about a bin pivot shaft mechanically connected to the frame ensure emptying of the storage bins; and
a device for measuring the weight of the grape harvest that has accumulated in the storage bins;
wherein each storage bin is connected to the associated bin bracket via load sensors, the load sensors being elongate shaped bending sensors each having two fastening ends, a first fastening end being fastened to the storage bin and a second fastening end being fastened to the associated bin bracket so that the storage bin suspended from the associated bin bracket;
wherein the fastening ends of the load sensors are arranged above the shaking assembly when the machine is located on a horizontal planar ground;
wherein each load sensor is powered by the grape harvest weight measuring device to output a sensor signal at any time; and
wherein the measuring device is configured to process the signals of the load sensors and to continuously or cyclically output a measurement signal representative of a grape harvest weight accumulated by the grape harvesting machine into the storage bins.

2. The grape harvesting machine according to claim 1, wherein, for each storage bin, the fastening ends of the load sensors are arranged above a center of gravity of the storage bin when the machine is located on a horizontal planar ground.

3. The grape harvesting machine according to claim 1, wherein, for each storage bin, when the machine is located on a horizontal planar ground, the center of gravity of the vacuum storage bin is located more than 15% of a depth of the storage bin under the fastening ends.

4. The grape harvesting machine according to claim 1, comprising:
for each storage bin, at least three load sensors suspending the storage bin from the bin bracket, distributed so that two of these sensors are distant by at least 60% of the width of the storage bin according to a direction substantially parallel to the wheel train axis, and that two of these sensors are distant by at least 70% of a length of the storage bin according to a substantially horizontal direction and perpendicular to the wheel train axis, wherein the storage bin being considered in the mechanical grape harvesting position on a horizontal planar ground.

5. The grape harvesting machine according to claim 4, which comprises, for each storage bin, four load sensors suspending the storage bin, a first and a second of these sensors being arranged at a front portion of the storage bin, and distant from each other by at least 60% of the width of the storage bin according to a direction substantially parallel to the wheel train axis, a third and a fourth of these load sensors being arranged at a rear portion of the storage bin and distant from each other by at least 60% of the width of the storage bin, the first and third of the load sensors being distant from each other by at least 70% of the length of the storage bin according to a substantially horizontal direction and perpendicular to the wheel train axis, the storage bin being considered in the grape harvesting position on a horizontal planar ground.

6. The grape harvesting machine according to claim 1, wherein, for each storage bin, the storage bin includes bin rising edges, the first fastening ends of the load sensors being fastened at less than 20% of a width of the storage bin from one of said bin rising edges.

7. The grape harvesting machine according to claim 1, wherein, for each storage bin, at least one of the load sensors is located between the storage bin and a driver cabin of the grape harvesting machine and has a longitudinal axis substantially parallel to the wheel train axis of the grape harvesting machine.

8. The grape harvesting machine according to claim 1, wherein, for each storage bin, a ratio of a sum of absolute values of the capacities of the load sensors to an expected maximum total weight of the storage bin is greater than 2.
